(19) United States
(12) Patent Application Publication
(10) Pub. No.: US 2013/0300831 A1
(43) Pub. Date: Nov. 14, 2013

(54) CAMERA SCENE FITTING OF REAL WORLD SCENES

(71) Applicant: Loren Mavromatis, (US)

(72) Inventors: Theofanis Mavromatis, Manhattan Beach, CA (US); Fiona C. Yeung, Redondo Beach, CA (US); Mark A. Pumar, Northridge, CA (US); Harrison A. Parks, Los Angeles, CA (US)

(21) Appl. No.: 13/469,759

(22) Filed: May 11, 2012

(51) Int. Cl. H04N 5/225; H04N 13/02; H04N 5/217

(52) U.S. Cl. 348/46; 348/E05.024

(57) ABSTRACT

A system fits a camera scene to real world scenes. The system receives from an image sensing device an image depicting a scene, a location of the image sensing device in real world coordinates, and locations of a plurality of points in the scene in the real world coordinates. Pixel locations of the plurality of points are determined and recorded. The center of the image is determined, and each pixel in the image is mapped to an angular offset from the center of the image. Vectors are generated. The vectors extend from the image sensing device to the locations of the plurality of points, and the vectors are used to determine a pose of the image sensing device.

### TECHNICAL FIELD

The current disclosure relates to fitting a camera scene to a real world scene, and in an embodiment, but not by way of limitation, fitting a camera field of view into a real world scene and obtaining an accurate camera pose.

### BACKGROUND

Geo-location is the accurate determination of an object's position with respect to latitude, longitude, and altitude (also referred to a real world coordinates). Currently, most intelligent video systems do not do this. While a few advanced products attempt to geo-locate objects of interest by approximating the camera pose, the methods used tend to be error prone and cumbersome, and errors tend to be high. Other systems detect objects and project their locations onto a surface that is usually planar. For such systems, there is no requirement to accurately “fit” the camera view to the real world scene.

There are a few advanced systems that claim to geo-locate targets based on video use approximation methods during system calibration. For example, such systems might use people walking within the camera scene carrying a stick of known length while the camera viewer attempts to create a 3-D perspective throughout the scene. Using this method, a 3-D perspective of the ground can be formed by having the person within the scene hold the stick vertically at various places in the scene while a person viewing the scene generates a grid. This process can be time consuming, and the grid is defined and based on video rather than by using the actual scene. Consequently, if the camera is removed and repositioned due to maintenance or some other reason, the same costly and time consuming process must be repeated. Additionally, the scene matching accuracy can be relatively low as there is usually no metric for grid accuracy, and the perspective can only be defined on the areas to which a person has access. Thus, the method is usually not suitable if high accuracy is required. This is particularly true for the geo-location of objects detached from the terrain (e.g., flying objects), or for objects found in areas that were inaccessible during the calibration and 3D depth setup.

### BRIEF DESCRIPTION OF THE DRAWINGS

FIG. 1 is a block diagram of a process to fit a camera scene to a real world scene.

FIGS. 2A, 2B, and 2C are other diagrams of a process to fit a camera scene to a real world scene.

FIG. 3 illustrates a camera scene geodetic survey using a land surveying total station.

FIG. 4 illustrates a graphical implementation of a camera scene fitting.

FIG. 5 is a diagram of features and steps of a process of fitting a camera scene to a real world scene.

FIG. 6 is a block diagram of a computer system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present disclosure describes a process for accurately and efficiently fitting a camera field of view into a real world scene and obtaining an accurate camera pose, as well as accurately mapping camera pixels to real world vectors originating at the camera and pointing to objects in the camera scene. An embodiment of the process does not depend on camera terrain perspective approximations. Moreover, once the process is performed, it does not need to be repeated if a camera is removed and replaced due to maintenance, or due to some other reason, which is not the case with prior art systems.

In an embodiment, a three step process offers significant advantages when compared to prior art systems used in intelligent video surveillance products. Specifically, the three step process offers higher accuracy by taking advantage of a highly accurate geodetic survey, as well as highly accurate and highly resolute camera imagery. Existing methods are primarily based only on video and operator-based terrain modeling, which tend to have higher errors, especially in complex scenes or uneven terrain. The process further takes advantage of fast and accurate camera field-of-view mapping of existing methods that accurately compute camera distortions. The process takes the additional step to map the scene back to the distorted camera view resulting in a fast, simple, and highly accurate process for camera scene matching. Unlike existing methods, once the first two steps of the described process are performed, one needs only to perform the third step to match the camera scene in the event that a camera is nudged or removed and replaced due to maintenance.

Intelligent video-based systems that are capable of producing high accuracy three-dimensional (3-D) or surface-based tracks of objects require an accurate “fitting” of the real world scene as viewed by each of the system's cameras. This is particularly necessary when performing 3-D tracking via the use of multiple cameras with overlapping fields of view, since this requires high accuracy observations in order to properly correlate target positions between camera images. An embodiment is a fast, efficient, and highly accurate process to perform this task. The methodology is a significant improvement over existing processes, and it can help in reducing both cost and time during the installation, use, and maintenance of video surveillance systems requiring high accuracy.

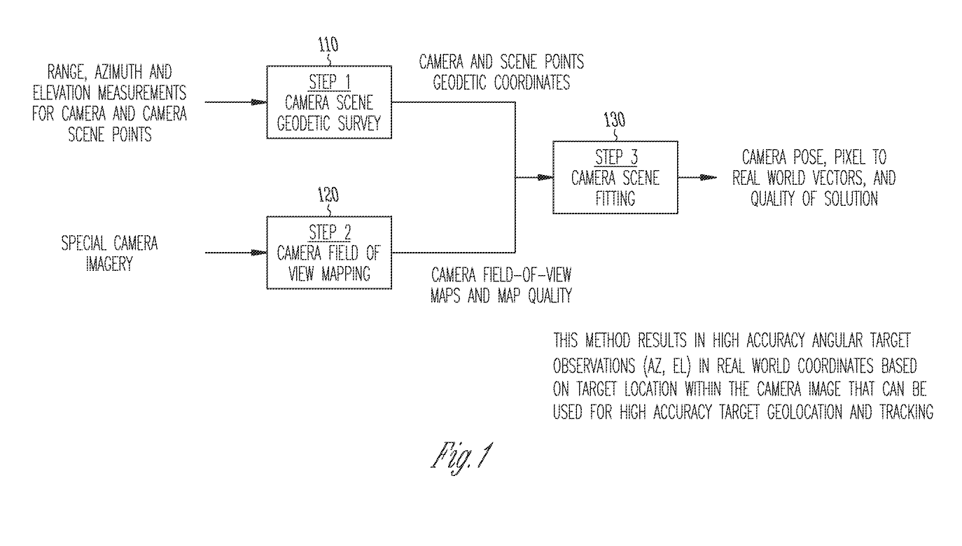

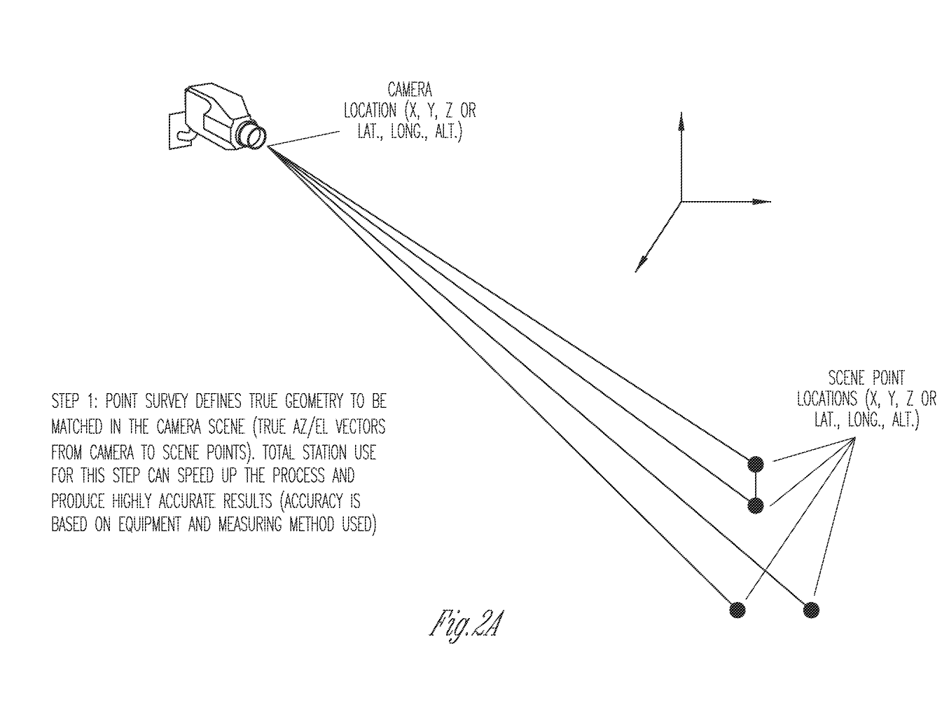

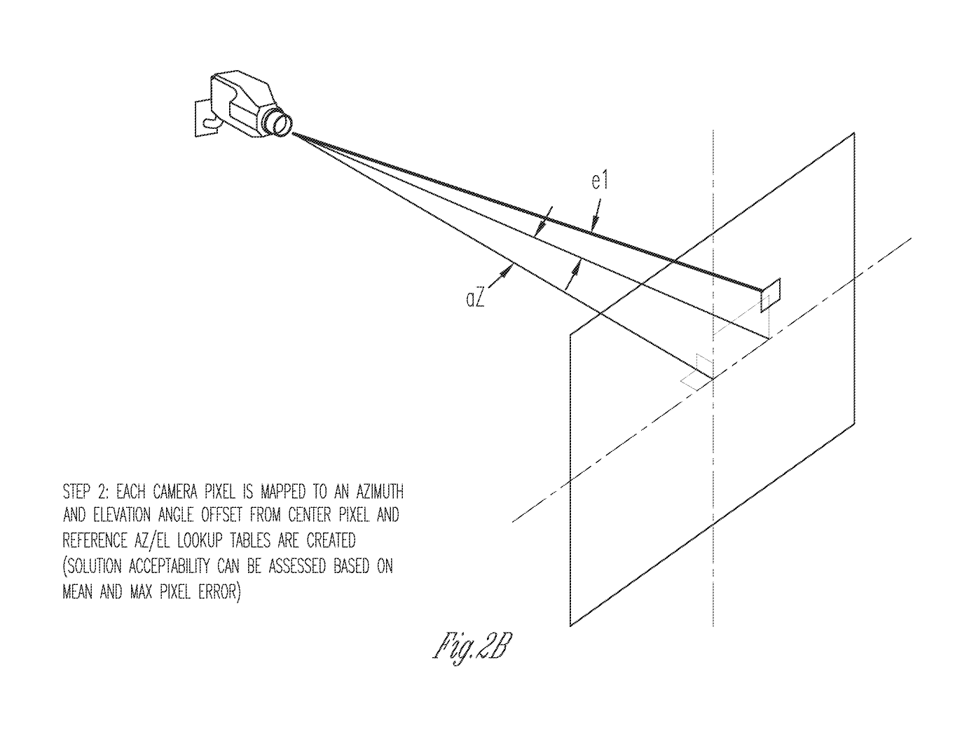

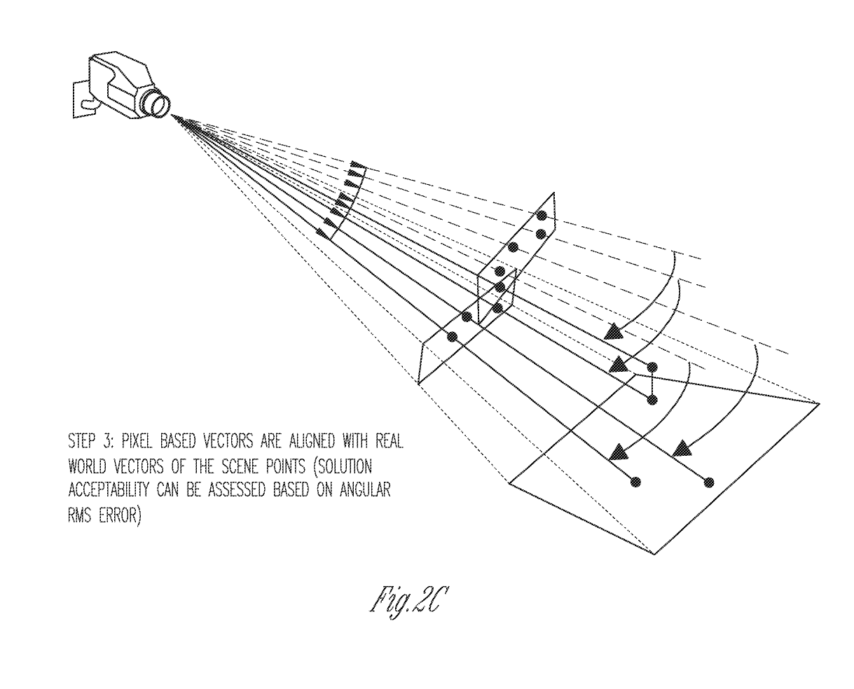

An embodiment consists of three distinct steps, each of which contains metrics to determine acceptable accuracy levels towards meeting a wide range of system accuracy requirements. The three steps of this process are as follows, and the steps are illustrated in block diagram form in FIGS. 1, 2A, 2B, and 2C.

First, at 110, a camera scene geodetic survey is executed. In this step, the camera and several distinct points within the camera scene are surveyed and their positions are recorded.

Second, at 120, a camera field of view mapping is executed. In this step, each pixel in the camera image gets mapped and the angular offsets from the center of the image for each pixel are tabulated. This step accounts for all major error sources such as focal plane tilting and optical distortions such as pin cushion and barrel distortion.

Third, at 130, a camera scene fitting is executed. In this step, a manual or automated selection of the geo-surveyed points within the camera scene from the first step is performed utilizing the camera field-of-view mapping of the second step to accurately determine camera pose resulting in an optimum fit of the camera scene into real world coordinates.

For a fixed camera location at a fixed zoom setting, the first and second steps only need to be performed once, even if the camera is removed and replaced due to maintenance or other reasons. In that case, only the selection of a few of the surveyed points from the image needs to be performed to re-determine a camera's pose. The third step is the fastest of the three steps. Even if the third step is performed manually, it typically only requires a few mouse clicks on the surveyed points within the camera scene. This results in a highly accurate scene fitting solution. As noted, the three steps are illustrated in a block diagram in FIG. 1, and each of the three steps is described below in more detail.

Block 110 in FIG. 1 and FIG. 2A are referred to as the camera scene geodetic survey, which involves the use of standard methods for determining the accurate geo-locations of points within the scene of a camera. To accomplish this, a person views the output of the camera and determines points that are visible and unlikely to be displaced. Once these points are determined, conventional geodetic survey methods are used to obtain accurate point and camera positions. In an embodiment, a fast, efficient, and highly accurate method for doing this is to use a “total station” such as those used by land surveyors.

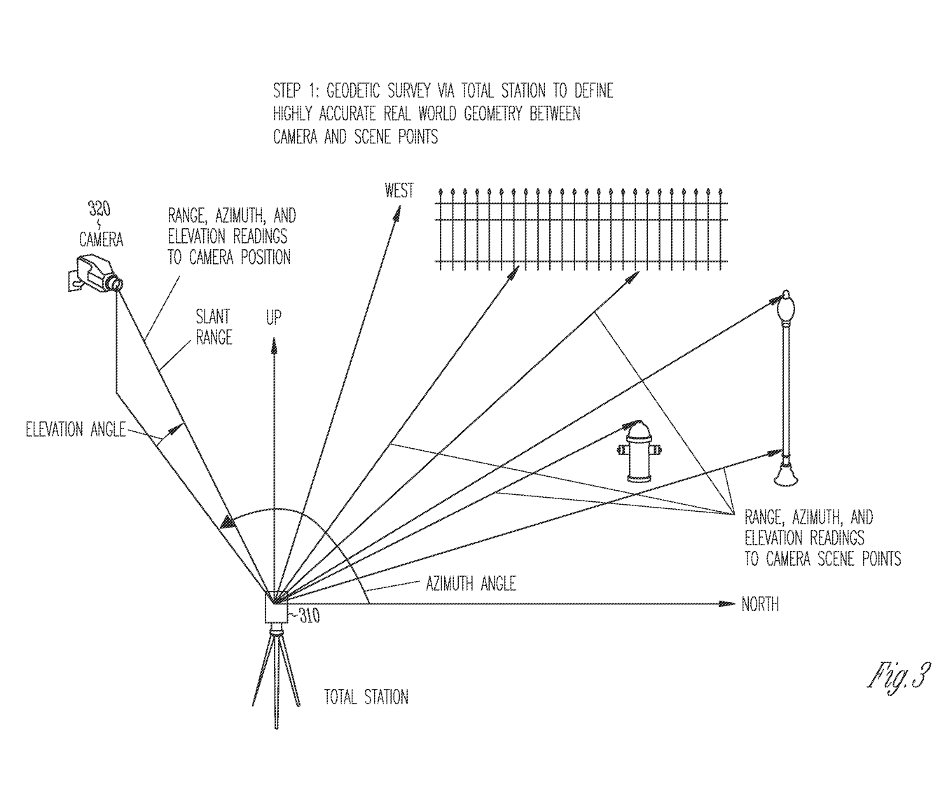

Referring to FIG. 3, the total station 310 is used to record the range, elevation angle, and azimuth angle readings for each of the points of interest within the cameras' scene, as well as the cameras' positions. These readings, along with the total station's geo-location, are used to compute the accurate geo-locations of the entire scene's points of interest and the positions of the camera 320. Although other methods can be used to perform the first step of a camera geodetic survey, the total station method results in highly accurate geo-locations and can be performed in a relatively short amount of time without the need for long or specialized training. A single survey session could survey multiple points and multiple cameras, thereby significantly reducing the “per camera” time needed to perform this first step. Also, this first step does not need to be repeated unless the camera pointing changes significantly and additional scene points are needed to re-fit the camera scene.

Block 120 in FIG. 1 and FIG. 2B can be referred to as the camera field of view mapping, and it maps every pixel in the camera's image to a pair of angular offsets (right/left and up/down) from the camera's center pixel or boresight. Several distinct methods can be used to perform this second step. One method is to take advantage of tools like the ones described in OpenCV (Open Source Computer Vision Library) to generate a camera model and estimate its distortions via the use of a flat checkerboard pattern. OpenCV is a library of programming functions mainly aimed at real time computer vision. The library is cross-platform, and focuses mainly on real-time image processing. More information on OpenCV can be found at opencv.willowgarage.com.

The second step 120 consists of two parts. The first part characterizes and removes camera optical distortions. An example method is described in Open CV that characterizes and removes distortions from the camera's field-of-view by collecting multiple images of a checkerboard pattern at different perspectives throughout the entire camera field-of-view. The second part is a new process that utilizes the results from the first part to generate offset angles from the boresight for each camera pixel based on both the true and the distorted camera field-of-view. A metric that quantifies the error statistics of this pixel's offset angle mapping is also defined. One of the advantages of this particular field-of-view mapping method is that it can be performed in the field for mounted and operational cameras without the need for removing the cameras to calibrate them offsite. This second step can be performed in a short period of time for each camera and it does not need to be repeated unless the camera's field-of-view changes (e.g., by changing the camera lens zoom setting). Once this step is completed, all pixels in the camera field of view will have a pair of angular offsets (up-down and right-left) from the camera boresight. The boresight angular offsets are zero.

The two parts of the second step 120 can be further explained as follows. A first part of the second step 120 uses an Open CV chessboard method to compute a camera's intrinsic parameters (cx, cy), distortions (radial: k1, k2, k3; tangential: p1, p2), and undistorted x″, y″ mapping. The Open CV chessboard method can also be used to display an undistorted image for an accuracy check. A second part of the second step 120 uses an optimization algorithm to solve for reverse (distorted) x′ y′ mapping, given x″, y″ and distortions (k1, k2, k3, p1, p2). Azimuth and elevation projection tables are distorted on the image plane using the just described reverse x′ y′ mapping.

The two parts of the second step 120 can be described in more detail as follows. The functions in this section use the so-called pinhole camera model. That is, a scene view is formed by projecting 3D points into the image plane using a perspective transformation.

$${sm}^{′} = A [ R \vert t ] {M}^{′}$$

$$or$$

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

Where (X, Y, Z) are the coordinates of a 3D point in the real world coordinate space (latitude, longitude, and altitude), and (u, v) are the coordinates of the projection point in pixels. A is referred to as a camera matrix, or a matrix of intrinsic parameters. The coordinates (cx, cy) are a principal point (that is usually at the image center), and fₓ, f_{y} are the focal lengths expressed in pixel-related units. Thus, if an image from a camera is scaled by some factor, all of these parameters should be scaled (i.e. multiplied or divided respectively) by the same factor. The matrix of intrinsic parameters does not depend on the scene viewed, and once estimated, the matrix can be re-used (as long as the focal length is fixed (in the case of zoom lens)).

The joint rotation-translation matrix [R|t] is called a matrix of extrinsic parameters. It is used to describe the camera motion around a static scene, or vice versa, and the rigid motion of an object in front of a still camera. That is, [R|t] translates coordinates of a point, (X, Y, Z) to some coordinate system, fixed with respect to the camera. The transformation above is equivalent to the following (when z≠0):

$$[ \begin{matrix}x \\ y \\ z\end{matrix} ] = R [ \begin{matrix}X \\ Y \\ Z\end{matrix} ] + t$$

$${x}^{′} = x \text{/} z$$

$${y}^{′} = y \text{/} z$$

$$u = {f}_{x} * {x}^{′} + {c}_{x}$$

$$v = {f}_{y} * {y}^{′} + {c}_{y}$$

Real lenses usually have some distortion, mostly radial distortion and slight tangential distortion. So, the above model is extended as:

$$[ \begin{matrix}x \\ y \\ z\end{matrix} ] = r [ \begin{matrix}X \\ Y \\ Z\end{matrix} ] + t$$

$${x}^{′} = x \text{/} z$$

$${y}^{′} = y \text{/} z$$

$${x}^{″} = {x}^{′} ( 1 + {k}_{1} {r}^{2} + {k}_{2} {r}^{4} + {k}_{3} {r}^{6} ) + 2 {p}_{1} {x}^{′} {y}^{′} + {p}_{2} ( {r}^{2} + 2 {x}^{′2} )$$

$${y}^{″} = {y}^{′} ( 1 + {k}_{1} {r}^{2} + {k}_{2} {r}^{4} + {k}_{3} {r}^{6} ) + {p}_{1} ( {r}^{2} + 2 {y}^{′2} ) + 2 {p}_{2} {x}^{′} {y}^{′}$$

$$where {r}^{2} = {x}^{′2} + {y}^{′2}$$

$$u = {f}_{x} * {x}^{″} + {c}_{x}$$

$$v = {f}_{y} * {y}^{″} + {c}_{y}$$

k₁, k₂, k₃ are radial distortion coefficients, p₁, p₂ are tangential distortion coefficients. It is noted that higher-order coefficients are not considered in OpenCV.

Block 130 in FIG. 1 and FIG. 2C can be referred to as the camera scene fitting step, and it utilizes the results of the first two steps to optimally fit the camera's field-of-view into the real world scene. For this, an automated or operator-driven manual process matches each point in the camera scene to the previously geo-surveyed points determined in the first step (e.g., by mouse clicking on the corresponding pixel of the point of interest within the scene). Angular offsets for each pixel derived from the second step are used to generate vectors from the camera to the designated points in the scene. These pixel-based vectors are then compared to the camera-to-point vectors computed from the real world survey of the first step. An iterative method for optimally aligning the pixel-derived vectors with the real world survey-based vectors is then performed. The output of this process is a rotation matrix describing the camera's pose along with a metric based on the angular root mean square (RMS) error between the pixel-based and survey-based vectors. The rotation metric quantifies the accuracy of the scene fitting process. This step can be performed in a very short period of time (e.g., in one or two minutes) and can be easily repeated if the cameras are nudged or remounted.

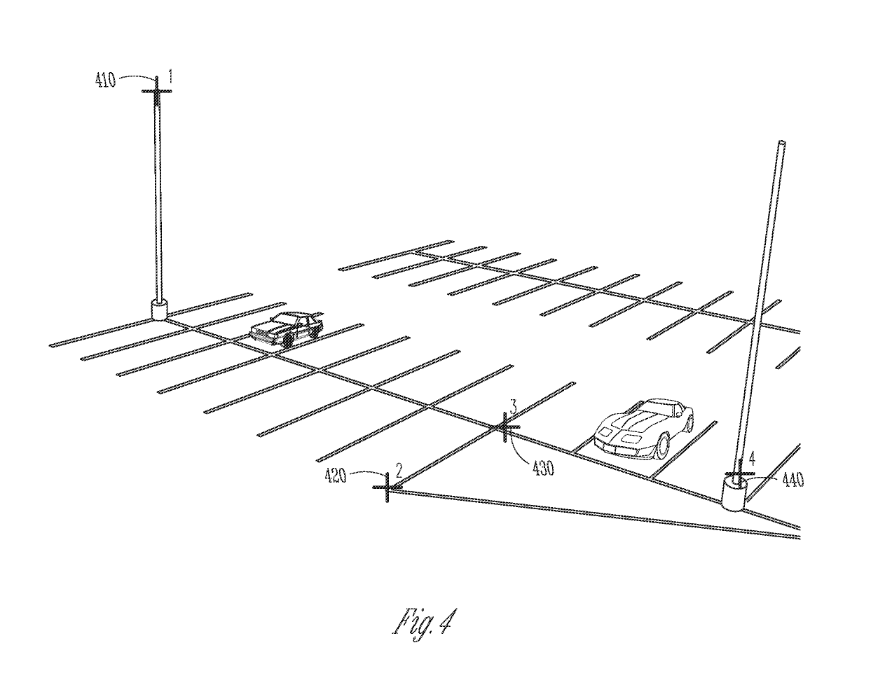

FIG. 4 illustrates a graphical implementation of the third step 130. In this example, the surveyed coordinates of the camera location and of four fixed points 410, 420, 430 and 440 in the camera scene are obtained from the first step 110, and the camera field-of-view maps are obtained from the second step 120. For the third step 130, an operator matches the four surveyed points (410, 420, 430 and 440) on the scene as shown in FIG. 4, and an optimization algorithm minimizes the angular errors between the true camera-to-points geometry (obtained from the first step 110) and the video based geometry (with camera location information from the first step's camera field-of-view mapping information from the second step 120 and operator inputs from the third step 130). The output of this process is a rotation matrix describing the camera pose along with a metric that is based on angular RMS error among the pixel-based and survey-based vectors that quantifies the accuracy of the scene fitting process. This step can be performed in a very short period of time (e.g., very few minutes) and can be easily repeated if the cameras get “nudged” or removed and then reinstalled due to maintenance or other reasons.

The above-described three step method for accurately fitting the camera scene into the real world can be implemented in different ways that result in a highly accurate, highly efficient, and very fast camera scene fitting. This is especially beneficial for a multi-camera, intelligent detection, tracking, alerting, and cueing system. If the camera pose changes or the camera is remounted after maintenance, only the third step 130 is necessary for recalibration. If the camera zoom setting changes, only the second step 120 and the third step 130 are necessary for recalibration.

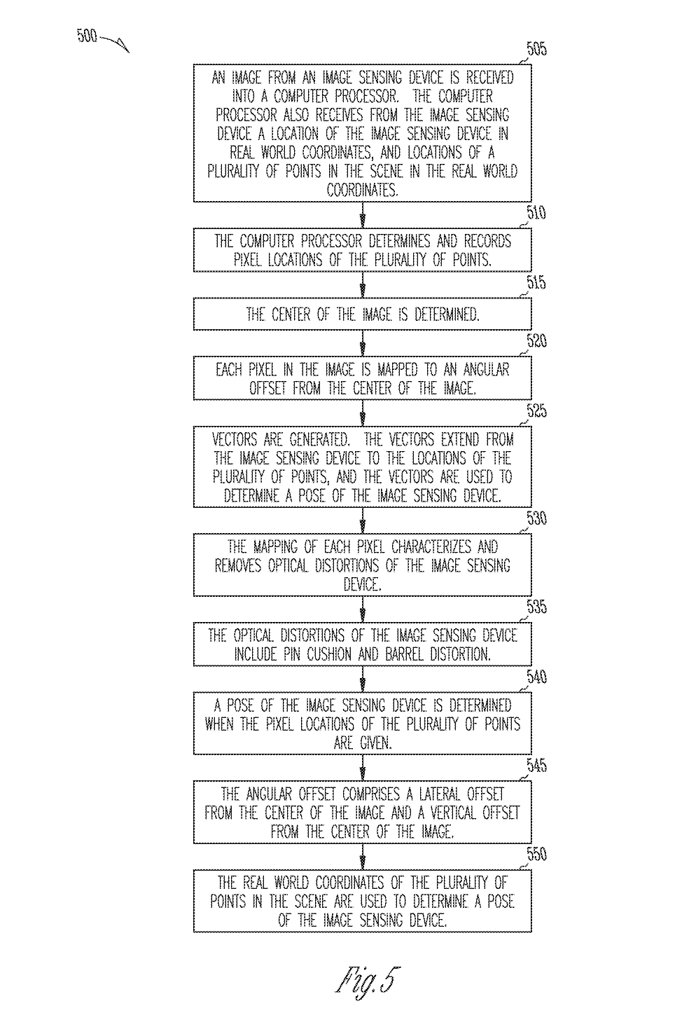

FIG. 5 is a block diagram of features and steps of an example process 500 for fitting a camera scene to a real world scene. FIG. 5 includes a number of feature and process blocks 505-550. Though arranged serially in the example of FIG. 5, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 505, an image from an image sensing device is received into a computer processor. The image depicts a scene from the field of view of the image sensing device. In an embodiment, the image sensing device is a video camera. The computer processor also receives from the image sensing device a location of the image sensing device in real world coordinates, and locations of a plurality of points in the scene in the real world coordinates. At 510, the computer processor determines and records pixel locations of the plurality of points. At 515, the center of the image is determined. At 520, each pixel in the image is mapped to an angular offset from the center of the image. Lastly, at 525, vectors are generated. The vectors extend from the image sensing device to the locations of the plurality of points, and the vectors are used to determine a pose of the image sensing device.

At 530, the mapping of each pixel characterizes and removes optical distortions of the image sensing device. At 535, the optical distortions of the image sensing device include pin cushion and barrel distortion. At 540, a pose of the image sensing device is determined when the pixel locations of the plurality of points are given. At 545, the angular offset comprises a lateral offset from the center of the image and a vertical offset from the center of the image. At 550, the real world coordinates of the plurality of points in the scene are used to determine a pose of the image sensing device.

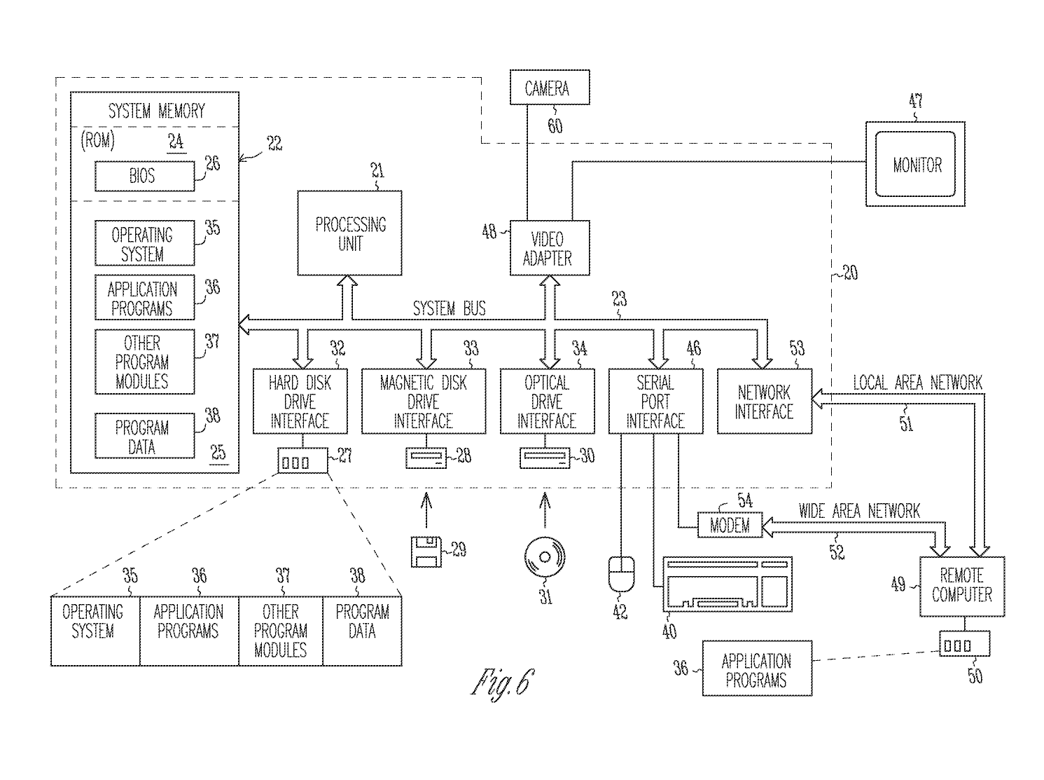

FIG. 6 is an overview diagram of hardware and operating environments in conjunction with which embodiments of the invention may be practiced. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 6, a hardware and operating environment is provided that is applicable to any of the servers and/or remote clients shown in the other Figures.

As shown in FIG. 6, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers. A camera 60 can also be connected to the system bus 23 via video adapter 48.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 6 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor configured to:
receive from an image sensing device an image depicting a scene, a location of the image sensing device in real world coordinates, and locations of a plurality of points in the scene in the real world coordinates;
determine and record pixel locations of the plurality of points;
determine a center of the image;
map each pixel in the image to an angular offset from the center of the image; and
generate vectors from the image sensing device to the locations of the plurality of points to determine a pose of the image sensing device.

2. The system of claim 1, wherein the mapping of each pixel characterizes and removes optical distortions of the image sensing device.

3. The system of claim 2, wherein the optical distortions of the image sensing device include pin cushion and barrel distortion.

4. The system of claim 1, wherein the computer processor is configured to determine a pose of the image sensing device when the pixel locations of the plurality of points are given.

5. The system of claim 1, wherein the angular offset comprises a lateral offset from the center of the image and a vertical offset from the center of the image.

6. The system of claim 1, wherein the computer processor is configured to use the real world coordinates of the plurality of points in the scene to determine a pose of the image sensing device.

7. A computer readable storage device comprising instructions that when executed by a processor execute a process comprising:
receiving from an image sensing device an image depicting a scene, a location of the image sensing device in real world coordinates, and locations of a plurality of points in the scene in the real world coordinates;
determining and recording pixel locations of the plurality of points;
determining a center of the image;
mapping each pixel in the image to an angular offset from the center of the image; and
generating vectors from the image sensing device to the locations of the plurality of points to determine a pose of the image sensing device.

8. The computer readable storage device of claim 7, wherein the mapping of each pixel characterizes and removes optical distortions of the image sensing device.

9. The computer readable storage device of claim 8, wherein the optical distortions of the image sensing device include pin cushion and barrel distortion.

10. The computer readable storage device of claim 7, comprising instructions for determining a pose of the image sensing device when the pixel locations of the plurality of points are given.

11. The computer readable storage device of claim 7, wherein the angular offset comprises a lateral offset from the center of the image and a vertical offset from the center of the image.

12. The computer readable storage device of claim 7, comprising instructions for using the real world coordinates of the plurality of points in the scene to determine a pose of the image sensing device.

13. A process comprising:
receiving from an image sensing device an image depicting a scene, a location of the image sensing device in real world coordinates, and locations of a plurality of points in the scene in the real world coordinates;
determining and recording pixel locations of the plurality of points;
determining a center of the image;
mapping each pixel in the image to an angular offset from the center of the image; and
generating vectors from the image sensing device to the locations of the plurality of points to determine a pose of the image sensing device.

14. The process of claim 13, wherein the mapping of each pixel characterizes and removes optical distortions of the image sensing device.

15. The process of claim 14, wherein the optical distortions of the image sensing device include pin cushion and barrel distortion.

16. The process of claim 13, comprising determining a pose of the image sensing device when the pixel locations of the plurality of points are given.

17. The process of claim 13, wherein the angular offset comprises a lateral offset from the center of the image and a vertical offset from the center of the image.

18. The process of claim 13, comprising using the real world coordinates of the plurality of points in the scene to determine a pose of the image sensing device.
